(19) United States
(12) Patent Application Publication
(10) Pub. No.: US 2012/0143746 A1
(43) Pub. Date: Jun. 7, 2012

(54) METHOD AND SYSTEM FOR PRICING AND ALLOCATING SECURITIES

(75) Inventor: Benjamin George Wentworth Bucknell, Woollahra (AU)

(73) Assignee: BUCKNELL TECHNOLOGIES PTY LTD, Woollahra, New South Wales (AU)

(21) Appl. No.: 13/390,108

(22) PCT Filed: Aug. 12, 2010
(86) PCT No.: PCT/AU2010/001027

§ 371 Date: Feb. 11, 2012

(30) Foreign Application Priority Data
Aug. 12, 2009 (AU) 2009903787

(51) Int. Cl. G06Q 40/04

(52) U.S. Cl. 705/37

(57) ABSTRACT

A method and system for pricing and allocating identified securities of a company on a registered securities exchange, as opposed to an off-market offer. A host computer system receives bid data indicative of one or more bids for the identified securities from one or more eligible investors. Novel methods and algorithms are applied in a determination of at least one price of the identified securities and an allocation of the identified securities to the one or more eligible investors.

### TECHNICAL FIELD

The present invention generally relates to a method of and system for pricing and allocating securities.

### BACKGROUND

Presently, already listed companies generally raise equity capital through one of the following described methods.

A “Pro Rata Offer” to all shareholders, which is not conducted via an exchange (i.e. a registered securities exchange), that is the offer is made “off-market”. The issuer sets a price at which new securities (e.g. shares) will be offered and each shareholder is entitled to apply for new securities, with entitlements determined pro rata by reference to their pre-offer shareholdings.

A “Share Purchase Plan”, which is also not conducted via an exchange, that is the offer is made “off-market”. The issuer invites shareholders to apply for an equal dollar value amount of new securities (e.g. shares) offered at the lower of a pre-specified price or price determined by a formula referencing the traded price of the securities since the announcement of the offer. Most jurisdictions limit the dollar amount which may be offered annually to each shareholder without shareholder approval (for example in Australia the limit is currently AU$15,000).

A “Placement”, which is again not conducted via an exchange, that is the offer is made “off-market”. Most jurisdictions permit securities to be issued on a non-pro rata basis without a prospectus to investors that satisfy a “sophisticated” or “professional” investor test. The process of pricing and allocating placements operates as follows:

i. bids are by invitation only and often only extended to institutional money managers—despite the law generally permitting much wider participation;

ii. the price at which new securities are issued may be fixed or may be established under an off-market process referred to as a “bookbuild”, which is generally conducted manually, and always subject to the discretion of the lead manager(s) and/or the issuer to determine pricing and allocations after all bids from prospective buyers have been received.

Under a bookbuild method, institutional money managers are invited to bid for various numbers of securities at various prices. Bids are collated off-market (i.e. not on a securities exchange) in a “book” maintained by a lead manager. The “book” is not publicly disclosed (i.e. bidders are not aware of the price and volume of other bidder's bids). The lead manager determines when the book is closed, then has discretion to:

i. set the price of new securities (usually in consultation with the issuer); and

ii. determine the amount (i.e. allocation) of new securities allocated to each bidder.

In most instances, the price is set at a discount to the pre-issue price and below the demand curve (i.e. at a price where there is more demand than supply) and each bidder's application is scaled back (usually not equally) at the discretion of the lead manager. This means that the price is artificially low, enhancing post-issue returns to successful bidders (at the expense of greater dilution to existing shareholders).

The discretionary, manual off-market bookbuild method is currently used for the issue of new shares for companies that are already listed (“private placements”), for the pricing and allocation of shares of unlisted companies when such companies list for the first time (an “Initial Public Offering”) and for the transfer of a number (usually a large holding) from one seller to a number of buyers (a “Sell-Down”).

In the reverse embodiment, companies may reduce their capital through offering to buy-back shares in the company through an off-market bookbuild by inviting shareholders to tender their shares at various asking prices. The company will then aggregate demand and buy-back shares that have been tendered at or below a certain price (determined by the lead manager after all tenders have been received). The buy-back shares are then typically cancelled by the company. The pricing and identification of successful bids is currently conducted by an off-market process where the match price is not calculated in real time, but rather at the end of the off-market bookbuild when all shares have been tendered.

The currently used bookbuild method causes various issues, for example a lack of fairness due to preferential treatment of certain shareholders or classes of investor through the capacity of lead manager to exercise discretion. Also, in the currently used method there is an inability to identify and contact all potential eligible bidders to satisfactorily access all potential market demand to influence the price of new securities. Furthermore, in the currently used method there is an inability for investors or shareholders to increase (decrease) their bids in response to real time information and transparency as to the cumulative bids (asks) in the bookbuild process.

Reference to securities should be broadly read as any type of negotiable instrument representing financial value, including for example equity securities (such as common stocks, shares, derivative contracts) and debt securities (such as banknotes, bonds or debentures).

There is a need for a method, system and/or computer program product which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### BRIEF SUMMARY

According to a first aspect, there is provided a method, system, computer-readable storage medium having computer-executable instructions and/or computer program product for pricing and allocating identified securities, which may be new securities (i.e. issued or unissued) or transferring an identifiable holding of existing securities of a company, or buy-back of existing securities on a registered securities exchange.

According to a second aspect, there is provided a method, system, computer-readable storage medium having computer-executable instructions and/or computer program product for determining at least one price of identified securities, which may be new securities (i.e. issued or unissued) or transferring an identifiable holding of existing securities, or buy-back of existing securities on a registered securities exchange.

According to a third aspect, there is provided a method, system, computer-readable storage medium having computer-executable instructions and/or computer program product for an allocation of the identified securities, or transfer of the identifiable holding of existing securities, to one or more eligible investors, or buy-back (and possible cancellation) from tendering shareholders on a registered securities exchange.

In a particular example, there is provided a method of pricing and allocating identified securities of a company on a registered securities exchange, including using at least one processing system for performing the steps of: receiving one or more bids for the identified securities from one or more eligible investors; and, determining at least one price of the identified securities and an allocation of the identified securities to the one or more eligible investors. Preferably, the identified securities are new securities (i.e. issued or unissued) or an identifiable holding of existing securities in the case of a sell-down or buy-back.

In another particular example, there is provided a system for pricing and allocating identified securities of a company on a registered securities exchange, including one or more servers configured to: receive bid data indicative of one or more bids for the identified securities from one or more eligible investors; and, determine price data indicative of at least one price of the identified securities and allocation data indicative of an allocation of the identified securities to the one or more eligible investors.

According to another aspect, there is provided a computer-implemented method of pricing and allocating identified securities of a company on a registered securities exchange, the method providing a bookbuild and comprising: allocating a unique trading code for the identified securities on the registered securities exchange; receiving, by a host computer system, bid data indicative of at least one bid by an eligible investor for at least some of the identified securities; and, determining, by the host computer system, and at least partially based on the bid data, at least one price for the identified securities and an allocation of the identified securities to the eligible investor.

According to another aspect, there is provided a host computer system for pricing and allocating identified securities of a company on a registered securities exchange, comprising: at least one processor to associate a unique trading code with the identified securities on the registered securities exchange; and, an input device to receive bid data indicative of at least one bid by an eligible investor for at least some of the identified securities; wherein, the at least one processor determines, at least partially based on the bid data, at least one price for the identified securities and an allocation of the identified securities to the eligible investor.

According to another aspect, there is provided a computer-readable storage medium having computer-executable instructions for pricing and allocating identified securities of a company on a registered securities exchange, the computer-executable instructions configured to: associate a unique trading code with the identified securities on the registered securities exchange; receive bid data indicative of at least one bid by an eligible investor for at least some of the identified securities; and, determine, at least partially based on the bid data, at least one price for the identified securities and an allocation of a number of the identified securities to the eligible investor.

According to another aspect, there is provided a computer-implemented method of determining at least one buy-back price for a company to purchase already issued company securities from a seller of the already issued company securities on a registered securities exchange, the method comprising: receiving, by a host computer system, offer data indicative of at least one offer by the company for at least some of the already issued company securities; and, determining, by the host computer system, and at least partially based on the offer data, the at least one buy-back price for the already issued company securities.

Preferably, the method is performed in real time.

In yet another example form, determining the at least one price of the identified securities is at least partially based on a selection implemented in the host computer of: a total number of the identified securities; or a total value of the identified securities.

In yet another example form, determining the at least one price of the identified securities is at least partially based on a selection implemented in the host computer of: a single price to be determined for the identified securities; or different prices to be determined for the identified securities.

In yet another example form, the single price is determined by calculating when an excess of a total number of bids over a total number of identified securities to be issued is reached, or when an aggregated volume of bids remain unsatisfied after allocating the identified securities.

Preferably, the different prices are determined at least partially based on bids received from eligible investors.

In yet another example form, the single price is determined based on at least one parameter selected from the group consisting of: an excess coverage; a minimum price; a priority allocation for the eligible investor; and, a maximum value allocated to the eligible investor.

In yet another example form, the at least one price and the allocation are determined at least partially based on the further steps of: determining, by the host computer system, a match price satisfying the condition of an excess demand being equal to a pre-determined percentage over a supply; and, identifying, by the host computer system, if the at least one bid is equal to or in excess of the match price.

In yet another example form, the at least one price and the allocation are determined at least partially based on the further steps of: identifying, by the host computer system, if a bid is a priority bid and has been increased to the match price; and, allocating a percentage of the supply to the priority bid.

In yet another example form, an eligible investor identified from an off-market bookbuild is associated with a firm bid at a minimum price which conveys a priority status for the allocation of the identified securities if the firm bid is increased to the final match price.

In yet another example form, selecting whether a total number of the identified securities to be issued is fixed or is to be determined by a dollar value; selecting whether the identified securities are to be issued at a fixed price or at a number of different prices; and determining, by the host computer, the at least one price and the allocation.

In yet another example form, the allocation is: a Bid Driven Allocation based on an ordering of prices submitted under bids; or, a Pro-rata Driven Allocation based on bids for a proportion of a number of securities.

In yet another example form, if different prices are to be determined for the identified securities then the allocation is based on individual bid prices until: a total number of securities to be issued has been allocated; or there are no unsatisfied bids equal to or above a minimum price.

In yet another example form, determining the at least one buy-back price further includes: selecting whether a total number of the already issued company securities to be purchased by the company is fixed or is to be determined by a dollar value; and, selecting whether the already issued company securities are to be purchased by the company at a fixed price or at a number of different prices.

In yet another example form, identifying a successful seller is based on the determined buy-back price.

In yet another example form, the at least one buy-back price is above a price at which a cumulative supply is equal to a fixed demand for the already issued company securities.

In yet another example form, the at least one buy-back price is determined based on at least one parameter selected from the group consisting of: an excess coverage; a maximum price; a priority allocation; and, a maximum value allocation.

In yet another example form, an eligible seller identified from an off-market reverse bookbuild is associated with a firm ask at a maximum price which conveys a priority status for the buy-back of the securities if the ask is decreased to a final match price.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates a flow diagram of an example method of pricing and allocating identified securities of a company or transferring existing securities by way of bookbuild on a registered securities exchange;

FIG. 2A illustrates a structure diagram of an example system for pricing and allocating a sub-set of a company's securities on a registered securities exchange;

FIG. 2B illustrates a structure diagram of another example system for pricing and allocating a sub-set of a company's securities on a registered securities exchange;

FIG. 3 illustrates a functional block diagram of an example processing system that can be utilised to embody or give effect to a particular embodiment;

FIG. 4 illustrates an example network infrastructure that can be utilised to embody or give effect to a particular embodiment.

### PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

### Overview

In example embodiments there is provided a method of, system for and/or computer program product for pricing and allocating securities. These embodiments can include, for example, where either: the cumulative supply of identified securities to be sold is to be determined via a bookbuild process and the demand is fixed (either in terms of a dollar value or a number of securities); or, the cumulative demand for identified securities to be issued is to be determined via a bookbuild process and the supply is fixed (either in terms of a dollar value or a number of securities).

Preferably, though not necessarily: a match price and eligible bids (eligible asks) are determined on a real time basis during, and not after, the bidding process; and, an allocation and/or pricing of identified securities, i.e. new or already issued existing securities, occurs on a registered securities exchange.

Identified securities should be read as a reference to new securities or an identifiable holding of existing securities. New securities may be issued or unissued securities. For example, in some countries (e.g. Australia) new securities such as shares are not issued at the time of a bookbuild. However, in some other countries (e.g. Canada and the United States of America) new securities such as shares may be issued prior to a bookbuild. Bids can include a bid price for securities and a bid volume of securities.

In a particular non-limiting example, the allocation and/or the pricing can be determined by:

calculating a ‘match’ price where the excess demand (excess supply) is equal to a pre-determined percentage over fixed supply (fixed demand) (e.g. 150%);

identifying all bids equal to or in excess (equal to or below) of the match price (“eligible bids”) (“eligible asks”);

in certain iterations, identifying or determining all initial firm bids that have been increased (decreased) to the match price (priority bids) (“priority asks”);

allocating, in certain iterations, a percentage, for example a pre-determined percentage, of supply to the priority bids (priority asks); and

allocating the remaining unallocated shares on a pro-rata basis amongst the eligible bids (eligible asks).

For clarity, embodiments of the present invention are distinguished from, for example, methods and trading systems which facilitate the transfer of already issued securities between a seller and buyer of those securities, where a price is determined through matching supply and demand equally. In another example, there is also a distinction from methods for collating demand or supply of securities, whether issued or not, where the price and/or allocations are determined after all bids (on behalf of bidders or suppliers) have been received at the discretion of the issuer and/or lead manager.

In an example embodiment there is provided a method of pricing and allocating identified securities of a company, preferably though not necessarily a listed company, on a registered securities exchange, as opposed to an off-market bookbuild which presently occurs.

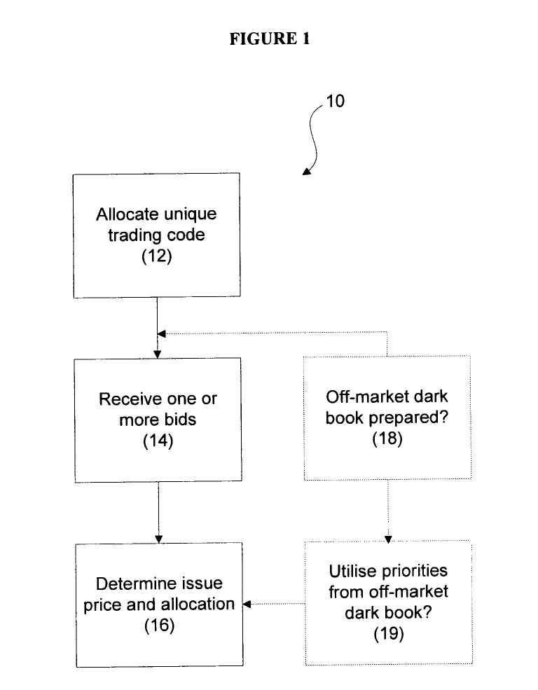

Referring to FIG. 1, there is illustrated a method 10 of pricing and allocating identified securities of a company on a registered securities exchange, which includes using at least one processing system, for example a host computer system. At step 12 a unique trading code is allocated for the identified securities to be priced and allocated via the registered securities exchange. At step 14 at least one bid is received by the host computer system for the identified securities from at least one client computer system used by or on behalf of at least one eligible investor. Subsequently, at step 16, at least one price of the identified securities can be determined by the host computer system and an allocation of the identified securities can be made to the at least one eligible investor. A bid by an eligible investor must include at least one bid price for securities and at least one bid volume of securities.

In one preferred form, the identified securities are new securities and the price is an issue price. In another preferred form, the identified securities are existing securities subject to a sell-down. Also preferably, the at least one price is less than a price at which a cumulative demand for the identified securities is equal to a fixed supply for the identified securities.

In a further example embodiment, pricing and allocating the identified securities on the registered securities exchange can be preceded by step 18 to produce an off-market bookbuild (i.e. “dark book”) which, if undertaken, can be subsequently followed by step 19 resulting in successful bidders from the off-market bookbuild having priority (for a limited percentage of their allocations from the dark book) in allocations in the on-exchange bookbuild. The allocations from the dark book can become the “opening firm bids” for the on-market bookbuild.

Novel methods/algorithms are utilised, preferably by the host computer system, to determine the at least one price and the allocation of the identified securities to potential investors. A plurality of different methods/algorithms for determining the price/allocation, by the host computer system, can be provided, with one or more specific methods/algorithms being chosen, for example by the issuer or lead manager, or automatically, to actually determine the final price(s) and allocation. Within each method/algorithm, a variety of parameters can be set/amended in the host computer system to reflect the issuer's or lead manager's preferences.

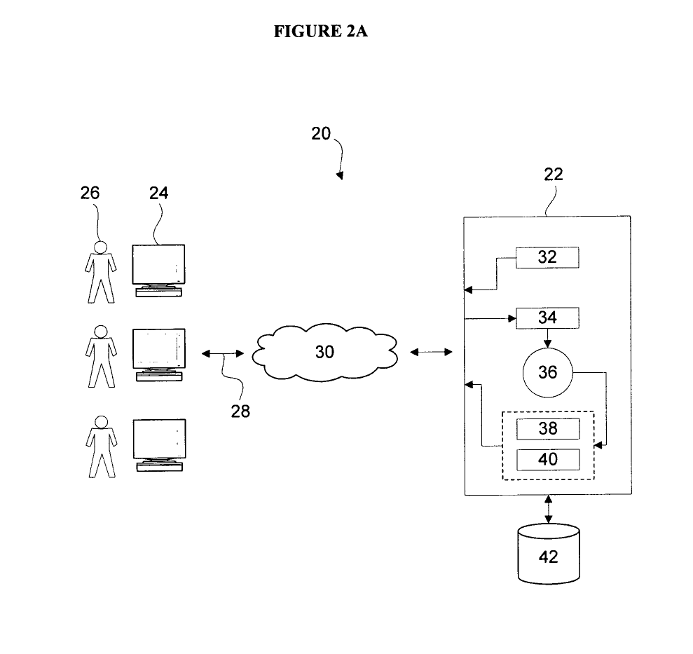

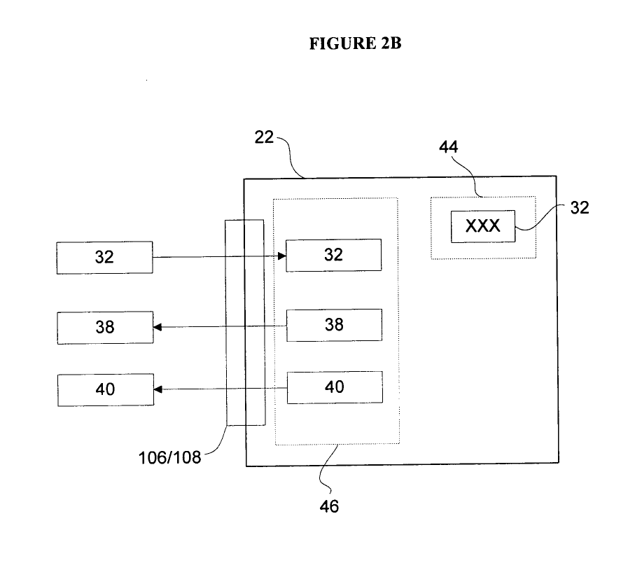

Referring to FIG. 2A, there is illustrated a system 20 for pricing and allocating identified securities of a company on a registered securities exchange. One or more securities exchange servers 22, i.e. the host computer system 22, provide at least one processing/host system on which method 10 can be performed. One or more terminals 24, i.e. at least one client computer system 24, can be used by or on behalf of at least one eligible investor 26 to send/receive data 28 to/from one or more exchange servers 22 via network 30. Determining if a person is an eligible investor can occur by a variety of ways, for example if the person verifies that they satisfy rules to be an eligible investor. Price data indicative of the at least one price and allocation data indicative of the allocation of the identified securities can be sent from the host computer system to at least one client computer system.

Exchange server(s) 22, i.e. the host computer system, allocate or associate a unique code 32 for identified securities, that may be actually selected by a human operator, which can be stored in or retrieved from database 42. A particular terminal 24, i.e. client computer system, receives unique code 32 to allow a particular eligible investor 26 to specify the identified securities of interest. Exchange server(s) 22 receive bid data 34 indicative of one or more bids from an eligible investor 26. Exchange server(s) 22 apply at least one algorithm 36 after receiving bid data 34. Price data 38, indicative of one or more prices, and allocation data 40, indicative of an allocation to the one or more eligible investors 26, are generated or produced using algorithm 36. Price data 38 and allocation data 40 can be communicated to or requested by terminals 24 via network 30. Data or information can be stored in and retrieved from database 42.

Software applications, modules and/or procedures can be used to provide functionality on the terminals 24 and exchange server(s) 22. Terminals 24 could be provided with a web browser or dedicated software application to interact with exchange server(s) 22. Functionality on the exchange server(s) 22 can be provided by dedicated programs, for example to implement algorithm 36 and associated parameters, and could utilise parts of existing software used on registered securities exchanges.

Referring to FIG. 2B, there is illustrated a host computer system 22 for pricing and allocating identified securities of a company on a registered securities exchange. The system 22 includes at least one processor so as to associate (automatically or based on manual input) a unique trading code 32 with the identified securities on the registered securities exchange. This process can be performed by software module 44. Input/Output device 106/108 is provided to receive bid data 32 indicative of at least one bid (e.g. including bid volume, bid price and/or conditional information such as a validity time) by an eligible investor for at least some of the identified securities. System 22 determines, at least partially based on the bid data 32, at least one price for the identified securities and an allocation of the identified securities to the eligible investor. The determining step can be provided by software module 46, which also calculates price data 38 indicative of the at least one price and allocation data 40 indicative of the allocation of the identified securities. Input/Output device 106/108 can then send price data 38 and allocation data 40 to at least one client computer system, for example being used by one or more eligible investors. Preferably, the determining steps and sending of data is performed in real time.

Software module 46 can determine at least one price of the identified securities at least partially based on a selection, either automated or manually effected, of a total number of the identified securities, or a total value of the identified securities. Software module 46 can also determine at least one price at least partially based on a selection, either automated or manually effected of a single price to be determined for the identified securities, or different prices to be determined for the identified securities.

Additionally, software module 46 can also determine a single price by calculating when an excess of a total number of bids over a total number of identified securities to be issued is reached, or when an aggregated volume of bids remain unsatisfied after allocating the identified securities. Different prices can be determined at least partially based on the bids received from eligible investors. Moreover, a single price can be determined by software module 46 based on at least one of the following parameters: an excess coverage; a minimum price; a priority allocation for the eligible investor; and/or, a maximum value allocated to the eligible investor.

Using software module 46, at least one price and an allocation can be further determined at least partially based on determining a match price satisfying the condition of an excess demand being equal to a pre-determined percentage over a supply, and identifying if the at least one bid is equal to or in excess of the match price. An price and an allocation also can be determined at least partially based on determining if an opening bid has been increased to the match price so as to identify a priority bid, and allocating a percentage of the supply to such a priority bid.

Software module 46 can additionally receive data indicating a priority status or level for an eligible investor. For example, an eligible investor can be identified from an off-market bookbuild as being associated with a priority status for the allocation of the identified securities.

Previously, when new issues of listed companies have been offered, such shares have been priced and allocated off-market and not via a securities exchange. Such shares have also previously been priced and allocated at the discretion of the issuer and/or lead manager and not according to pre-determined methods/algorithms. Also previously, the issuers and/or lead managers have not been able to select from a number of parameters to determine the pricing and allocation (i.e. to remove discretion from the pricing and allocation process after the bookbuild occurs).

Thus, according to various embodiments, it is advantageously provided for identified securities to be issued by way of placement to be priced and allocated as determined by methods/algorithms applied to bids made through a securities exchange. The commercial advantages include:

1. Expanding the number of bidders from invitation only by the lead manager to all eligible investors and the capacity for bidders to see real time match pricing results in improved pricing tension versus the current off-market, invitation only, zero price transparency process;

2. On-exchange bookbuilds enable corporate advisers to provide the lead manager's service effectively even where that corporate adviser's securities division does not have the leading market share in that issuer's securities;

3. Issuers and lead managers should face lower litigation threats as the allocations are determined by algorithmic rules rather than discretion;

4. The process is fairer, more equitable, more transparent and more inclusive than off-market bookbuilds for placements and IPOs and buy-backs;

5. The process addresses public concerns that investment banks are using their discretion in the allocation process to pay soft dollar brokerage to their trading clients, in conflict with the issuer's or seller's interest in attaining the highest (lowest) price for shares to be issued (bought-back) or transferred.

In a specific but non-limiting example, a registered securities exchange nominates a unique trading code to the securities to be issued or transferred and opens a bookbuild for identified securities. Bids for identified securities are restricted to investors who are eligible to bid under relevant laws. All eligible investors may lodge bids in the bookbuild for the identified securities. The final price and the allocation of securities is determined by at least one algorithm, which may be selected from a plurality of algorithms, and which can be agreed prior to the bookbuild, rather than pricing and allocations being determined at the discretion of the lead manager and/or issuer.

The issuer and/or lead manager can choose an algorithm for pricing of identified securities as either:

a single final price at which identified securities are issued, determined at the point that a pre-specified excess of total bids over total identified securities to be issued is reached or a specified aggregated volume of bids remain unsatisfied after the allocation process (“excess coverage”); or

different prices for each identified security to be issued determined by the price of bids lodged by bidders (i.e. eligible investors, applicants, etc.).

If an algorithm is used to issue all identified securities at the same price, then various parameters can be specified in the algorithm to determine pricing of identified securities, including, for example:

the excess coverage used to determine the final price;

the minimum price at which identified securities may be issued if the excess coverage is not reached;

priority for particular bidders which are identified as full priority bidders (cornerstone investors);

priority to a pre-specified percentage or number of firm irrevocable bids at a minimum price (potentially allotted in a “dark pool”), if any, who also increase their bid to the final price;

any caps on the total value or shares which may be allocated to a bidder or the bidder's associates.

A dedicated software program(s), or alternatively a web based interface such as a browser, could be used by an issuer or lead manager to set up and manage the identified securities offer on the host computer system, for example by selecting the desired algorithm(s) and setting the various parameters associated with specific algorithms to be applied by the host computer system. Server based applications can be used to implement pricing and allocating of the identified securities and to apply an algorithm to determine price(s) and an allocation of the identified securities. The algorithms are embodied as applied methods or in systems, preferably a computer-implemented method or processing system, and can be embodied as software applications, programs, procedures, modules, etc.

Preferably, the allocations determined by the on-market bookbuild constitute binding contracts. The identified securities to be issued may, or may not, be cleared through a clearing house.

Additionally, the method of issuing identified securities using a securities exchange may, or may not, be preceded by an invitation to institutional bidders to bid for the identified securities without disclosing other bids (i.e. “a dark pool”). A selected (discretionary) process can be used to determine priority allocations from the dark pool to create a “dark book” of successful bidders. If the on-exchange pricing does not result in a higher final price than the off-market dark book, then allocations from the dark book are binding (i.e. dark pool bids are irrevocable firm bids which become the opening and minimum price for the bookbuild). If the on-exchange pricing does result in a higher final price than the dark book, allocations from the dark book give successful bidders a right to increase their bid to match the final price.

If a successful dark book bidder exercises its right to match the final price:

(If) the securities offered in the dark book are included in the number offered in the on-exchange pricing and allocation—for successful bidders that increase their bids to the final price, priority in allocations from the on-market bookbuild in relation to a specified percentage of their allocations from the dark pool;

(If) the securities offered in the dark book are not included in the number offered on-market—for successful bidders that increase their bids to the final price, priority in allocations from the dark book in relation to a specified percentage of their allocations from the dark pool (which reflects the total number of securities issued through the on-market process rather than pursuant to the allocations made to participants in the dark pool).

The method may include an algorithm by which priority bidders enter a maximum price which the bidders would be willing to match (undisclosed to the market) and where the match price increases. These bids could then automatically increase to the match price, up to the maximum. This means priority bidders would not miss out on increasing their bid if the match jumps just before close of the bookbuild.

### Processing System and Network

In a networked information or data communications system, a user (e.g. an eligible investor, bidder, applicant, etc.) has access to one or more client terminals which are capable of requesting and/or receiving information or data from local or remote information sources. In such a communications system, a client terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a client terminal to request and/or receive information or data can be provided by software, hardware and/or firmware. A client terminal may include or be associated with other devices, for example a local data storage device such as a hard disk drive or solid state drive.

An information source can include one or more servers, such as a host computer system, or any type of terminal, that may be associated with one or more storage devices that are able to store information or data, for example in one or more databases residing on a storage device. The exchange of information (i.e., the request and/or receipt of information or data) between a client terminal and an information source (e.g. a securities exchange server or the host computer system), or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

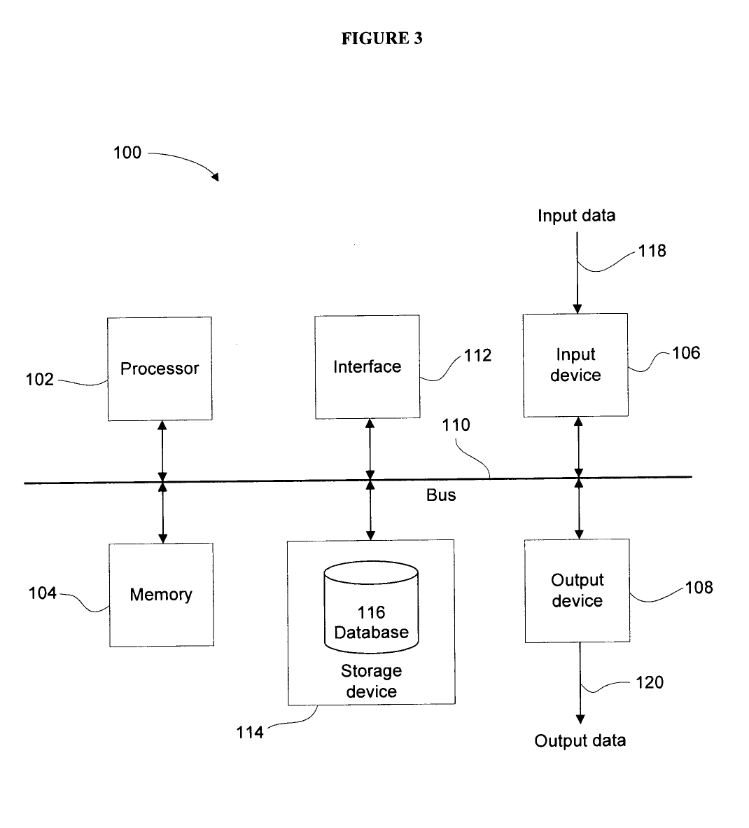

A particular example embodiment of the present invention can be realised using a processing system or host computer system, an example of which is shown in FIG. 3. In particular, the processing system 100, i.e. the host computer system, could be embodied as one or more servers providing a platform for a securities exchange. Processing system 100 (e.g. exchange server(s)) generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 (e.g. bid data 34 indicative of at least one bid, for example including a bid price and a bid volume, or a bid price range and/or a bid volume range) and can include, for example, a data receiver, network interface device, antenna such as a modem or wireless data adaptor, data acquisition card, etc. Input data 118 could come from different sources, for example keyboard instructions in conjunction with data received via a network. Output device 108 produces or generates output data 120 (e.g. price data 38 indicative of at least one price, and allocation data 40 indicative of the allocation of the identified securities) and can include, for example, a display device a data transmitter, network interface device, antenna such as a modem or wireless network adaptor, etc. Output data 120 could be distinct and derived from different output devices, for example a visual display on a monitor in conjunction with data transmitted to a network. A remote user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives information or instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

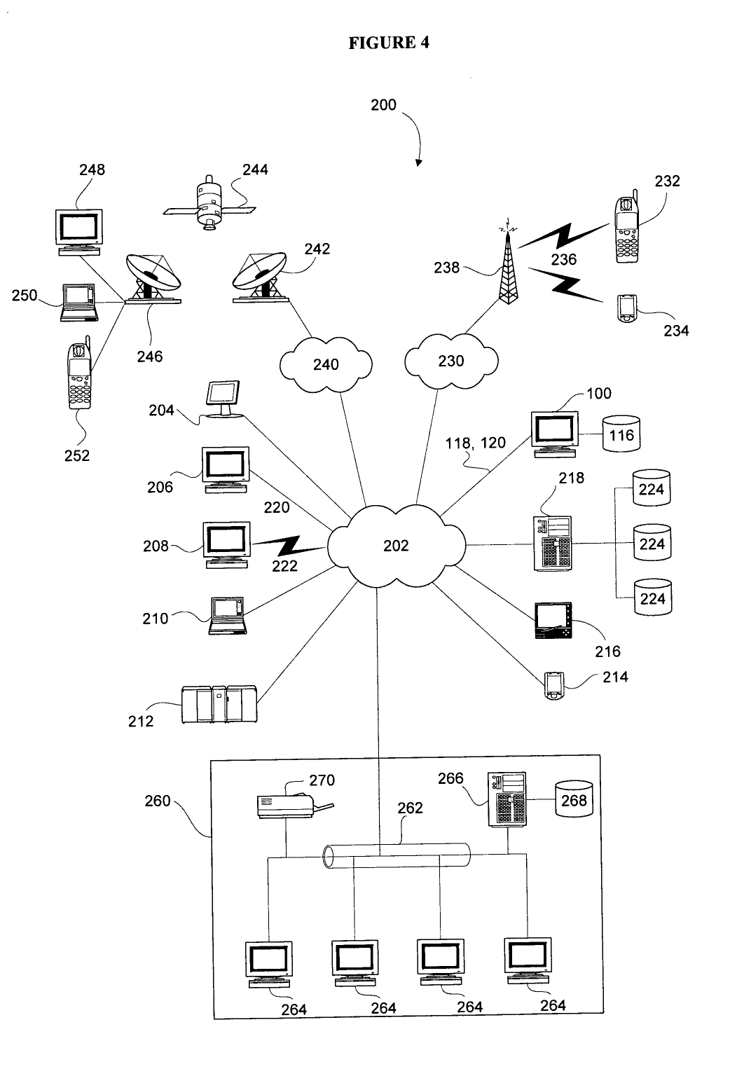

The processing system 100 may be a part of a networked communications system 200, as shown in FIG. 4. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

### Further Examples—Algorithms for Calculating Final Price and Allocations

The following examples provide a more detailed discussion of particular embodiments. The examples are intended to be merely illustrative and not limiting to the scope of the present invention.

The lead manager and/or issuer select which one or more algorithms, for example embodied as software application modules, determine pricing and allocation by the host computer system and can then set the following parameters for the relevant algorithms.

Certain aspects of the present invention include process steps or instructions described in the form of an algorithm. It should be noted that the process steps or instructions of the present invention could be embodied in software, firmware or hardware, and when embodied in software, could be downloaded to reside on and be operated from different platforms used by real time network operating systems.

The algorithms presented herein are not inherently related to any particular computer or other apparatus. Various computer systems may also be used with programs in accordance with the teachings herein, or it may prove convenient to construct more specialized apparatus to perform the required method steps. In addition, the present invention is not described with reference to any particular programming language. It is appreciated that a variety of programming languages may be used to implement the algorithms, process steps or instructions described herein.

Pricing:
i. whether the number of identified securities which will be issued is fixed (Placement No# Securities Fixed) or to be determined by a dollar value represented by the price times the final price (Placement Value Fixed);
ii. whether all securities will be issued at the same price (Algorithm 1: Volume driven with single price) or at a number of different prices (Algorithm 2: Bid price driven with multiple prices);
iii. if Algorithm 1 is selected, whether Algorithm 1a or 1b will determine the final price:
   Algorithm 1a: the final price will be determined as being the price at which the percentage or number of total shares bid for is equal to or less than a pre-specified excess of bids over the number of identified shares (Target Excess Coverage At Match);
   Algorithm 1b: the final price will be first determined by the percentage or number of total shares bid for (asked for) over the number of identified shares (Total Target Excess Coverage Over Match);
   (collectively, Target Excess Coverage)
iv. the Target Excess Coverage percentage or amount;
v. the minimum price at which the issuer is willing to issue identified securities (Minimum Price).

Allocations:
i. the identity of any bidders whose bids are to be given 100% priority (Cornerstone Investors) and the number of identified securities to which that priority relates (Cornerstone Investor Allocations);
ii. if a dark book has preceded the on-exchange pricing and allocation, the percentage of those applications which receive priority in the on-exchange bookbuild (Priority Allocation Percentage) or, if the dark pool securities are not included in the number of securities to be issued via the on-exchange method, the percentage of preliminary allocations from the dark pool which constitute final allocations of identified securities;
iii. a cap (maximum) on bid size, including associates of the bidder, if any, expressed as a number of identified securities (Bid Caps);
iv. if Algorithm 1 is selected, whether Algorithm 1a—Target Excess Coverage At Match, or Algorithm 1b—Total Target Excess Coverage Over Match, is selected.

The price for each identified security is determined by an approach involving the use of conditional decision rules in real time as the bookbuild occurs. If a clear result cannot be achieved when the first decision rule is applied, the model progresses to a second decision rule and so on. The decision rules are preferably always applied in the same order.

Algorithm 1: Determining a Final Price above the Minimum Price. Under Algorithm 1, all bids are filled at the same price regardless of the price actually stated when placing an order.

Principle 1: There are two steps involved in applying this principle. The first determines the cumulative bid quantities at each eligible price. The cumulative bid quantity increases as prices decrease—a buy price is the maximum that a buyer is willing to pay for their securities, however, it is accepted that the buyer is willing to pay a lower price. The second step determines a single final price.

Step 1: Determining the number of securities to be issued. If the Placement No# Securities Fixed method is chosen, then that number of securities will be issued regardless of the price. If Placement Dollar Value Fixed method is chosen, the Placement Dollar Value Fixed is divided by each eligible price to determine the number of securities to be issued at that price.

Step 2: Determining the final price. The highest price above the Minimum Price which causes: (a) if Algorithm 1(a) has been selected, the actual excess coverage to be less than or equal to the Target Excess Coverage At Match; or (b) if Algorithm 1(b) has been selected, the unfilled quantity to be less than or equal to the Total Target Excess Coverage Over Match amount. The filled quantity at each price level is equal to Total Cumulative Bids—Identified Shares to be issued.

If Step 2 results in a price, then this becomes the official final price and the pricing process concludes. If the application of Principle 1, Step 2 does not result in a final price, then the algorithm moves to Principle 2 to determine a final price and to recalculate the number of securities to be issued.

Principal 2: Determining a Final Price at the Minimum Price. The final price is the Minimum Price and the number of securities to be issued to on-market bidders is reduced to the cumulative bids at that price.

Algorithm 1: Allocations are determined using the following principles.

Principal 3: Cornerstone Investor Allocations at the Final Price are satisfied first.

Principal 4: Allocations under the dark book, if any, are multiplied by the Priority Allocation Percentage to determine the number of priority application securities for dark pool investors (Dark Pool Priority Shares). These investors receive next priority for up to the lesser of:
a) the Dark Pool Priority Shares; and
b) the number of shares for which the relevant dark pool bidder has lodged a bid at the Final Price.

Principal 5:

If Algorithm 1—Bid Driven Allocations has been selected, bids are satisfied, subject to any caps which have been specified, in order of the price submitted under the bid until the total number of securities allocated is equal to the number to be issued as calculated under Algorithm 1—Step 1. Any bids which have been allocated shares under an earlier principal are ignored to the extent of the allocation;

If Algorithm 1—Pro-rata Driven Allocations has been selected, all bids equal to and above the final price are considered to be bids at the final price. Each bidder then receives an allocation in proportion to the number of securities bid for, subject to any caps which have been specified, until the total number of securities allocated is equal to the number to be issued as calculated under Algorithm 1, Principal 1—Step 1.

Algorithm 2: Bid price driven with multiple prices. Best priced bids have priority and identified shares are allocated at each selected bid price (which may be at or below the actual bid price at each selected price) until either:

a) the total number of securities to be issued has been allocated; or
b) there are no unsatisfied bids equal to or above the minimum price.

If there is more than one order at the same price, the order that was placed first takes precedence.

The following worked examples are intended to be merely illustrative and not limiting to the scope of the present invention.

On-Market Bookbuilds—Worked Example (a “Placement”, Target Excess Coverage at Match, Algorithm 1a, Pro-Rata Driven Allocations)
1. A company wishes to raise $100 m new equity. Its shares are trading at $1.00.
2. Some lead managers offer to use a method embodying the present invention to enhance their prospects of winning the mandate.
3. The company mandates a lead manager that offers to use the method to access the pricing and corporate governance benefits.
4. The lead manager and company agree that the ‘underwritten’ price is $0.85 (a 15% discount).
5. The Dark Book (bid information is collated confidentially and disclosed only to selected clients, if any, at the discretion of the lead manager):
   a. The lead manager invites selected clients to bid for shares;
   b. The lead manager receives bids from 25 institutional clients to purchase $6 m of shares at 85 c ($150 m) and bids from its retail client base of $12.5 m at the final price (a total of $165 m of bids);
   c. The lead manager calls each of the institutional bidders, explains the bidding interest in the book and tells the bidder that they will need to lift their bid to 86 c if they wish to receive an allocation;
   d. At 86 c, collectively, there are bids from 20 institutional bidders for a collective total of $109 m, and the $12.5 million of bids from retail client (i.e. $121.5 m in total);
   e. The lead manager (and issuer) exercise their discretion to determine that 86 c is an appropriate price and to determine allocations. For example, the lead manager may allocate $98 million to its institutional clients (90% of their bids) and $2 m to its retail clients (16% of bids).
   Nb. This would be where the currently-used process ends, and $100 m of shares would be allotted to successful bidders at 86 c.
6. The Issuer/lead manager has set the “Excess Coverage” to 150% and “Priority Allocation” to 50% (the Priority Allocation would need to have been disclosed in Step 5 to induce the bidders to bid).
7. The allocations from Step 5 become the opening bids for the On-Market Bookbuild. These bids are irrevocable at 86 c, but can be increased to the final price to receive a priority.
8. On-Market Bookbuild commences and, with bidders able to see the match price. Broader participation results in $150 m of bids at 90 c (match price).
9. Those opening ‘firm’ bids that have been increased to 90 c receive 50% priority allocations.
10. Remaining unsatisfied bids (i.e. the “non-priority” part of the opening bids and the new bids at 90 c) receive allocations pro rata in respect of the volume of each bidders' bid at 90 c.

On-Market Bookbuilds—Worked Example (a “Buy Back”, Target Excess Coverage at Match, Algorithm 1a, Pro Rata Driven Allocations)
1. A company wishes to reduce its equity by $100 m. Its shares are trading at $1.00.
2. The company states that the buy-back price will be comprised of 80 c fully franked dividend (i.e. attaching a tax credit) and the remainder is a capital return.
3. To make the offer more attractive to shareholders, the company states that it will set a price based on where there is $150 m of shares tendered (i.e. 150% of supply).
4. The company opens an on-market bookbuild according to a method embodying the present invention.
5. Due to the attractiveness of the tax credit and the scale-back, shareholders tender shares below the trading price of $1.00.
6. As each shareholder can see the match price in real time, the shareholders can revise their asks downward to ensure that they can participate in the share buy-back (and receive the franking credit).
7. The company is able to purchase its shares back at a lower price than would otherwise be the case if the reverse bookbuild were carried out off-market without competitive tension. The company receives full value for the franking credits distributed.

It should be appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The present invention may take the form of a computer-implemented method, software embodiment, firmware, or an embodiment combining software and hardware aspects.

Although a preferred embodiment has been described in detail, it should be understood that various changes, substitutions, and alterations can be made by one of ordinary skill in the art without departing from the scope of the present invention.

1. A computer-implemented method of pricing and allocating identified securities of a company on a registered securities exchange, the method providing a bookbuild and comprising:
allocating a unique trading code for the identified securities on the registered securities exchange;
receiving, by a host computer system, bid data indicative of at least one bid by an eligible investor for at least some of the identified securities; and,
determining, by the host computer system, and at least partially based on the bid data, at least one price for the identified securities and an allocation of the identified securities to the eligible investor.

2. The computer-implemented method as claimed in claim 1, wherein the at least one price is less than a price at which a cumulative demand for the identified securities is equal to a fixed supply for the identified securities.

3. The computer-implemented method as claimed in claim 1, also comprising:
sending, from the host computer system to at least one client computer system, price data indicative of the at least one price and allocation data indicative of the allocation of the identified securities.

4. The computer-implemented method as claimed in claim 1, wherein the method is performed in real time.

5. The computer-implemented method as claimed in any one of claims 1 to 4, wherein determining the at least one price of the identified securities is at least partially based on a selection implemented in the host computer of:
a total number of the identified securities; or
a total value of the identified securities.

6. The computer-implemented method as claimed in any one of claims 1 to 5, wherein determining the at least one price of the identified securities is at least partially based on a selection implemented in the host computer of:
a single price to be determined for the identified securities; or
different prices to be determined for the identified securities.

7. The computer-implemented method as claimed in claim 6, wherein the single price is determined by calculating when an excess of a total number of bids over a total number of identified securities to be issued is reached, or when an aggregated volume of bids remain unsatisfied after allocating the identified securities.

8. The computer-implemented method as claimed in claim 6, wherein the different prices are determined at least partially based on bids received from eligible investors.

9. The computer-implemented method as claimed in claim 6, wherein the single price is determined based on at least one parameter selected from the group consisting of:
an excess coverage;
a minimum price;
a priority allocation for the eligible investor; and,
a maximum value allocated to the eligible investor.

10. The computer-implemented method as claimed in any one of claims 1 to 9, wherein the at least one price and the allocation are determined at least partially based on the further steps of:
determining, by the host computer system, a match price satisfying the condition of an excess demand being equal to a pre-determined percentage over a supply; and,
identifying, by the host computer system, if the at least one bid is equal to or in excess of the match price.

11. The computer-implemented method as claimed in claim 10, wherein the at least one price and the allocation are determined at least partially based on the further steps of:
identifying, by the host computer system, if a bid is a priority bid and has been increased to the match price; and,
allocating a percentage of the supply to the priority bid.

12. The computer-implemented method as claimed in claim 10, wherein an eligible investor identified from an off-market bookbuild is associated with a firm bid at a minimum price which conveys a priority status for the allocation of the identified securities if the firm bid is increased to the final match price.

13. The computer-implemented method as claimed in any one of claims 1 to 4, further including:
selecting whether a total number of the identified securities to be issued is fixed or is to be determined by a dollar value;
selecting whether the identified securities are to be issued at a fixed price or at a number of different prices; and
determining, by the host computer, the at least one price and the allocation.

14. The computer-implemented method as claimed in any one of claims 1 to 13, wherein the allocation is:
a Bid Driven Allocation based on an ordering of prices submitted under bids; or,
a Pro-rata Driven Allocation based on bids for a proportion of a number of securities.

15. The computer-implemented method as claimed in any one of claims 1 to 13, wherein if different prices are to be determined for the identified securities then the allocation is based on individual bid prices until:
a total number of securities to be issued has been allocated; or
there are no unsatisfied bids equal to or above a minimum price.

16. A host computer system for pricing and allocating identified securities of a company on a registered securities exchange, comprising:
at least one processor to associate a unique trading code with the identified securities on the registered securities exchange; and,
an input device to receive bid data indicative of at least one bid by an eligible investor for at least some of the identified securities;
wherein, the at least one processor determines, at least partially based on the bid data, at least one price for the identified securities and an allocation of the identified securities to the eligible investor.

17. The system as claimed in claim 16, also comprising:
an output device to send price data indicative of the at least one price and allocation data indicative of the allocation of the identified securities to at least one client computer system.

18. A computer-readable storage medium having computer-executable instructions for pricing and allocating identified securities of a company on a registered securities exchange, the computer-executable instructions configured to:
associate a unique trading code with the identified securities on the registered securities exchange;
receive bid data indicative of at least one bid by an eligible investor for at least some of the identified securities; and,
determine, at least partially based on the bid data, at least one price for the identified securities and an allocation of a number of the identified securities to the eligible investor.

19. A computer-implemented method of determining at least one buy-back price for a company to purchase already issued company securities from a seller of the already issued company securities on a registered securities exchange, the method comprising:
receiving, by a host computer system, offer data indicative of at least one offer by the company for at least some of the already issued company securities; and,
determining, by the host computer system, and at least partially based on the offer data, the at least one buy-back price for the already issued company securities.

20. The computer-implemented method as claimed in claim 19, wherein determining the at least one buy-back price further includes:
selecting whether a total number of the already issued company securities to be purchased by the company is fixed or is to be determined by a dollar value; and,
selecting whether the already issued company securities are to be purchased by the company at a fixed price or at a number of different prices.

21. The computer-implemented method as claimed in claim 19, including identifying a successful seller based on the determined buy-back price.

22. The computer-implemented method as claimed in any one of claims 19 to 21, wherein the at least one buy-back price is above a price at which a cumulative supply is equal to a fixed demand for the already issued company securities.

23. The computer-implemented method as claimed in any one of claims 19 to 22, wherein the at least one buy-back price is determined based on at least one parameter selected from the group consisting of:
an excess coverage;
a maximum price;
a priority allocation; and,
a maximum value allocation.

24. The computer-implemented method as claimed in any one of claims 19 to 23, wherein an eligible seller identified from an off-market reverse bookbuild is associated with a firm ask at a maximum price which conveys a priority status for the buy-back of the securities if the ask is decreased to a final match price.
